(19) United States
(12) Patent Application Publication
(10) Pub. No.: US 2006/0183841 A1
(43) Pub. Date: Aug. 17, 2006

(54) Thermally stable thermoplastic resin compositions, methods of manufacture thereof and articles comprising the same

(76) Inventors: Ashish Aneja, West Chester, PA (US); Bo Liu, Coatesville, PA (US); Kim G. Balfour, Delanson, NY (US); Lawrence D. Lucco, Parkesburg, PA (US)

Correspondence Address: GEAM - LNP-CE 08CE;IP LEGAL, ONE PLASTICS AVENUE, PITTSFIELD, MA, 01201-3697, US

(21) Appl. No.: 11/056,810

(22) Filed: Feb. 11, 2005

(51) Int. Cl. C08K 3/04

(52) U.S. Cl. 524/495; 524/430

(57) ABSTRACT

Disclosed herein is a thermoplastic article comprising a thermoplastic polymer having a glass transition temperature of greater than or equal to about 150° C.; and an electrically conductive filler; wherein the thermoplastic article when annealed to a temperature of greater than or equal to about 245° C. for a period of greater than or equal to about 24 hours produces a warpage of less than or equal to about 3 millimeters/100 square millimeters, expressed as a percentage, and wherein the article has a volume resistivity of less than or equal to about 10¹² ohm-cm and a surface resistivity of less than or equal to about 10¹⁰ ohm per square.

### BACKGROUND

This disclosure relates to thermally stable thermoplastic resin compositions, methods of manufacture thereof and articles comprising the same.

Trays used in the manufacture of computer chips are generally subjected to elevated temperatures of greater than or equal to about 245° C. during the manufacturing process. These trays are used to carry integrated circuit chips in the process. These trays often undergo deformation during such elevated temperature processes. Deformation of the trays causes the movement of chips thus the valuable chips can be damaged in the process.

It is therefore desirable to use trays manufactured from thermoplastic resin compositions that are dimensionally stable at temperatures of greater than or equal to about 245° C.

### SUMMARY

Disclosed herein is a thermoplastic article comprising a thermoplastic polymer having a glass transition temperature of greater than or equal to about 150° C.; and an electrically conductive filler; wherein the thermoplastic article when annealed to a temperature of greater than or equal to about 245° C. for a period of greater than or equal to about 24 hours produces a warpage of less than or equal to about 3 millimeters/100 square millimeters, expressed as a percentage, and wherein the article has a volume resistivity of less than or equal to about 10¹² ohm-cm and a surface resistivity of less than or equal to about 10¹⁰ ohm per square.

Disclosed herein too is a thermoplastic article comprising a thermoplastic polymer; wherein the thermoplastic polymer is a polyimide, a polyetherimide, a polyether ketone, a polyether ketone ketone, a polyether ether ketone, a polysulfone, a polyether sulfone, a polyarylene sulfide, or a combination comprising at least one of the foregoing thermoplastic polymers; and carbon fibers; wherein the thermoplastic article when annealed to a temperature of greater than or equal to about 245° C. for a period of greater than or equal to about 24 hours displays a warpage of less than or equal to about 3 millimeters/100 square millimeters, expressed as a percentage, and wherein the article has a volume resistivity of less than or equal to about 10¹² ohm-cm and a surface resistivity of less than or equal to about 10¹⁰ ohm per square.

Disclosed herein too is a method of manufacturing a thermoplastic article comprising blending a thermoplastic polymer with an electrically conductive filler in a manner effective to produce a thermoplastic article, which displays a warpage of less than or equal to about 3 millimeters/100 square millimeters, expressed as a percentage, when annealed to a temperature of greater than or equal to about 245° C. for a period of greater than or equal to about 24 hours and wherein the article has a volume resistivity of less than or equal to about 10¹² ohm-cm and a surface resistivity of less than or equal to about 10¹⁰ ohm per square.

Disclosed herein too is a thermoplastic composition comprising a thermoplastic polymer having a glass transition temperature of greater than or equal to about 150° C.; and an electrically conductive filler; wherein the thermoplastic composition when manufactured into an article that is annealed to a temperature of greater than or equal to about 245° C. for a period of greater than or equal to about 24 hours displays a warpage of less than or equal to about 3 millimeters/100 square millimeters, expressed as a percentage, and wherein the article has a volume resistivity of less than or equal to about 10¹² ohm-cm and a surface resistivity of less than or equal to about 10¹⁰ ohm per square.

### DETAILED DESCRIPTION OF FIGURES

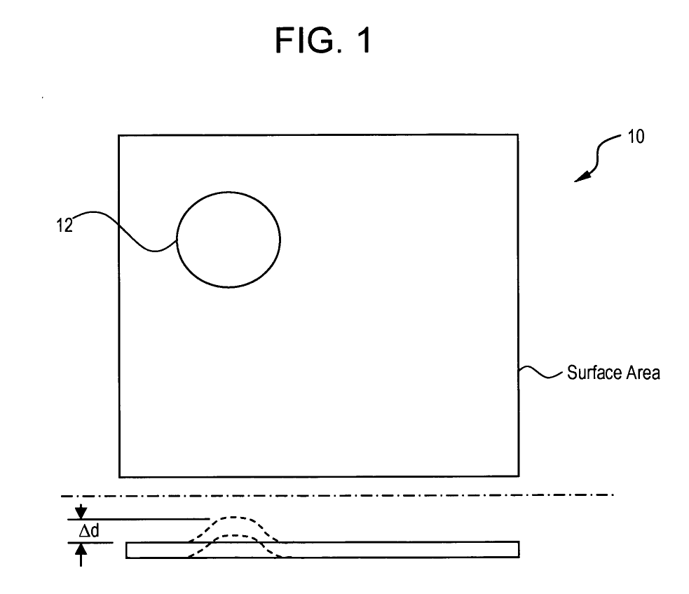

FIG. 1 is an exemplary depiction of how the warpage is measured. The warpage can be either convex or concave. Either the center of the tray is up off the testing surface or the corners are; and

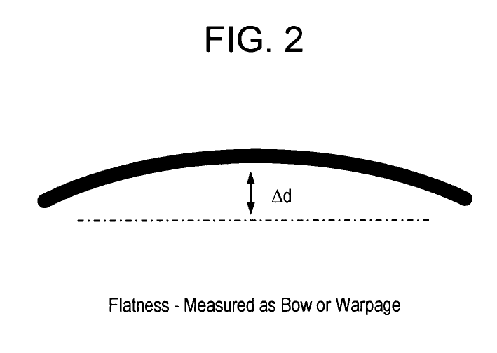

FIG. 2 is another exemplary depiction of bow and warpage and provides another example of how the warpage is measured.

### DETAILED DESCRIPTION

Disclosed herein are thermoplastic compositions that display dimensional stability at temperatures of greater than or equal to about 245° C. The thermoplastic compositions when molded into an article, advantageously display a warpage of less than or equal to about 3 millimeters (mm)/100 square millimeters, expressed as a percentage. In one embodiment, the article is an integrated circuit (IC) tray having dimensions meeting Joint Electron Device Engineering Council (JEDEC) specifications, i.e., having dimensions of 322.6 mm×135.9 mm×7.62 mm with warpage of less or equal to 0.76 mm. In one embodiment, the thermoplastic composition is electrically conductive and advantageously has a bulk volume resistivity of less than or equal to about 10¹² ohm-cm. In another embodiment, the thermoplastic composition has a surface resistivity of less than or equal to about 10¹² ohm/square.

With reference to FIG. 1, the warp factor is defined as total warp in millimeters (inches) divided by the total surface area of one surface of the molded article in millimeters (inches), expressed as a percentage. FIG. 1 displays two views of a square article 10 molded from the thermoplastic resin composition. The square article upon being subjected to annealing at a temperature develops an exemplary warpage indicated by the distorted section 12. The change in the lateral dimension is shown by “Δd” and is measured in millimeters or inches. The surface area is the area of one lateral surface of the article 10 measured in millimeters or inches. Warpage is measured relative to a flat surface. The warpage is measured either as a center or corner bow.

In one embodiment, warpage is defined to be the magnitude of bowing (convex or concave) in the surface of the article 10 relative to a planar reference axis. For IC boards, warpage can be detected using a warpage tester. A non-contact laser light can also be used to obtain the measurement. In another embodiment, when warpage is measured as a corner bow, surface warpage measurements can be made by measuring the heights of the four corner of the molding compound, average these heights and subtracting the average from the height of the center of the article 10 to arrive at the value Δd of the warpage. When such measurements are made, either the center of the article is up off the testing surface or the corners are. This is demonstrated in the FIG. 2. In the FIG. 2, the center of the article is up off the testing surface.

The thermoplastic resin composition comprises thermoplastic polymers having a glass transition temperature of greater than or equal to about 150° C. The thermoplastic polymers can be semi-crystalline or amorphous. The thermoplastic polymers can be oligomers, polymers, copolymers such as for example random copolymers, block copolymers, alternating copolymers, alternating block copolymers, star block copolymers, dendrimers, ionomers, or the like, or a combination comprising at least one of the foregoing polymers. Examples of suitable thermoplastic polymers that may be used are polyarylene sulfides, polyalkyds, polystyrenes, polyesters, polyamides, polyaramides, polyamideimides, polyarylates, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or a combination comprising at least one of the foregoing thermoplastic polymers.

In one embodiment, the thermoplastic polymer can be a polyimide, a polyetherimide or a combination comprising at least one of the foregoing thermoplastic polymers. In another embodiment, the thermoplastic polymer can be a polyether ketone, a polyether ketone ketone, a polyether ether ketone or a combination comprising at least one of the foregoing thermoplastic polymers. In yet another embodiment, the thermoplastic polymer can be a polysulfone, a polyether sulfone, a polyarylene sulfide or a combination comprising at least one of the foregoing thermoplastic polymers.

The thermoplastic polymers are generally present in the thermoplastic composition in an amount of about 40 to about 99 weight percent (wt %), based on the total weight of the thermoplastic composition. In one embodiment, the thermoplastic polymers are generally present in the thermoplastic composition in an amount of about 70 to about 98 wt %, based on the total weight of the thermoplastic composition. In yet another embodiment, the thermoplastic polymers are generally present in the thermoplastic composition in an amount of about 80 to about 95 wt %, based on the total weight of the thermoplastic composition.

Electrically conductive fillers that can be added to the composition are carbon nanotubes, carbon fibers, carbon black, metallic fillers, non-conductive fillers coated with metallic coatings, non-metallic fillers, or the like, or a combination comprising at least one of the foregoing electrically conductive fillers. Electrically conductive fillers are generally used in the thermoplastic composition in an amount of about 0.1 to about 80 wt %, based on the total weight of the thermoplastic composition if desired. Larger or lower quantities of the electrically conductive filler can be used depending upon the electrically conductive filler and the method of processing utilized.

Carbon nanotubes that can be used in the thermoplastic composition are single wall carbon nanotubes (SWNTs), multiwall carbon nanotubes (MWNTs), or vapor grown carbon fibers (VGCF). It is generally desirable to use carbon nanotubes having diameters of about 0.7 to about 500 nanometers. In one embodiment, the carbon nanotubes have diameters of 2 to about 100 nanometers. In another embodiment, the carbon nanotubes have diameters of 5 to about 25 nanometers. It is desirable for the aspect ratio of the carbon nanotubes to be greater than or equal to 5, prior to incorporation into the thermoplastic composition.

Carbon nanotubes are generally used in amounts of about 0.001 to about 80 wt % of the total weight of the thermoplastic composition. In one embodiment, carbon nanotubes are generally used in amounts of about 0.25 wt % to about 30 wt %, based on the total weight of the thermoplastic composition. In another embodiment, carbon nanotubes are generally used in amounts of about 0.5 wt % to about 10 wt %, based on the total weight of the thermoplastic composition. In yet another embodiment, carbon nanotubes are generally used in amounts of about 1 wt % to about 5 wt %, based on the total weight of the thermoplastic composition.

Various types of conductive carbon fibers may also be used in the composition. Carbon fibers are generally classified according to their diameter, morphology, and degree of graphitization (morphology and degree of graphitization being interrelated). These characteristics are presently determined by the method used to synthesize the carbon fiber. For example, carbon fibers having diameters down to about 5 micrometers, and graphene ribbons parallel to the fiber axis (in radial, planar, or circumferential arrangements) are produced commercially by pyrolysis of organic precursors in fibrous form, including phenolics, polyacrylonitrile (PAN), or pitch.

The carbon fibers generally have a diameter of greater than or equal to about 1,000 nanometers (1 micrometer) to about 30 micrometers. In one embodiment, the fibers can have a diameter of about 2 to about 10 micrometers. In another embodiment, the fibers can have a diameter of about 3 to about 8 micrometers.

Carbon fibers are used in amounts of about 0.001 to about 80 wt % of the total weight of the thermoplastic composition. In one embodiment, carbon fibers are used in amounts of about 0.25 wt % to about 30 wt %, based on the total weight of the thermoplastic composition. In another embodiment, carbon fibers are used in amounts of about 0.5 wt % to about 20 wt %, based on the total weight of the thermoplastic composition. In yet another embodiment, carbon fibers are used in amounts of about 1 wt % to about 10 wt %, based on the total weight of the thermoplastic composition.

Carbon black may also be used in the thermoplastic composition. Exemplary carbon blacks are those having average particle sizes less than about 200 nm. In one embodiment, carbon blacks having particle sizes of less than about 100 nm can be used. In another embodiment, carbon blacks having particle sizes of less than about 50 nm can be used. Exemplary carbon blacks may also have surface areas greater than about 200 square meter per gram (m²/g). In one embodiment, the carbon blacks can have surface areas of greater than about 400 m²/g. In another embodiment, the carbon blacks can have surface areas of greater than about 1000 m²/g. Exemplary carbon blacks may have a pore volume (dibutyl phthalate absorption) greater than about 40 cubic centimeters per hundred grams (cm³/100 g). In one embodiment, the carbon blacks can have surface areas of greater than about 100 cm³/100 g. In another embodiment, the carbon blacks can have surface areas of greater than about 150 cm³/100 g. In one embodiment, it is desirable for the carbon black to have a low ionic content (chlorides, sulfates, phosphates, fluorides, and nitrates) of less than or equal to about 4 parts per million per gram (ppm/g).

Carbon black is used in amounts of about 0.01 to about 80 wt % of the total weight of the thermoplastic composition. In one embodiment, carbon black is used in amounts of about 0.25 wt % to about 30 wt %, based on the total weight of the thermoplastic composition. In another embodiment, carbon black is used in amounts of about 0.5 wt % to about 20 wt %, based on the total weight of the thermoplastic composition. In yet another embodiment, carbon black is used in amounts of about 1 wt % to about 10 wt %, based on the total weight of the thermoplastic composition.

Solid conductive metallic fillers may also be used in the thermoplastic compositions. These may be electrically conductive metals or alloys that do not melt under conditions used in incorporating them into the thermoplastic polymers, and fabricating finished articles therefrom. Metals such as aluminum, copper, magnesium, chromium, tin, nickel, silver, iron, titanium, or the like, or a combination comprising at least one of the foregoing metals can be incorporated. Physical mixtures and true alloys such as stainless steels, bronzes, or the like, can also serve as conductive fillers. In addition, a few intermetallic chemical compounds such as borides, carbides, or the like, of these metals, (e.g., titanium diboride) can also serve as conductive filler particles. Solid non-metallic, conductive filler particles such as tin-oxide, indium tin oxide, antimony oxide, or the like, or a combination comprising at least one of the foregoing fillers may also be added to render the thermoplastic resins conductive. The solid metallic and non-metallic conductive fillers may exist in the form of powder, drawn wires, strands, fibers, tubes, nanotubes, flakes, laminates, platelets, ellipsoids, discs, and other commercially available geometries.

Regardless of the exact size, shape and composition of the solid conductive metallic and non-metallic conductive filler particles, they may be dispersed into the thermoplastic composition of loadings of 0.01 to about 80 wt %, based on the total weight of the thermoplastic composition. In one embodiment, the solid metallic and non-metallic conductive filler particles may be used in amounts of about 0.25 wt % to about 30 wt %, based on the total weight of the thermoplastic composition. In another embodiment, the solid conductive metallic and non-metallic conductive filler particles may be used in amounts of about 0.5 wt % to about 20 wt %, based on the total weight of the thermoplastic composition. In yet another embodiment, the solid conductive metallic and non-metallic conductive filler particles may be used in amounts of about 1 wt % to about 10 wt %, based on the total weight of the thermoplastic composition.

Non-conductive, non-metallic fillers that have been coated over a substantial portion of their surface with a coherent layer of solid conductive metal may also be used in the thermoplastic compositions. The non-conductive, non-metallic fillers are commonly referred to as substrates, and substrates coated with a layer of solid conductive metal may be referred to as “metal coated fillers”. Typical conducting metals such as aluminum, copper, magnesium, chromium, tin, nickel, silver, iron, titanium, and mixtures comprising any one of the foregoing metals may be used to coat the substrates. Examples of such substrates include silica powder, such as fused silica and crystalline silica, boron-nitride powder, boron-silicate powders, alumina, magnesium oxide (or magnesia), wollastonite, including surface-treated wollastonite, calcium sulfate (as its anhydride, dihydrate or trihydrate), calcium carbonate, including chalk, limestone, marble and synthetic, precipitated calcium carbonates, generally in the form of a ground particulates, talc, including fibrous, modular, needle shaped, and lamellar talc, glass spheres, both hollow and solid, kaolin, including hard, soft, calcined kaolin, and kaolin comprising various coatings to facilitate compatibility with the polymeric matrix resin, mica, feldspar, silicate spheres, flue dust, cenospheres, fillite, aluminosilicate (armospheres), natural silica sand, quartz, quartzite, perlite, tripoli, diatomaceous earth, synthetic silica, and mixtures comprising any one of the foregoing. All of the above substrates may be coated with a layer of metallic material for use in the thermoplastic compositions.

The metal coated fillers may be dispersed into the thermoplastic composition of loadings of 0.01 to about 80 wt %, based on the total weight of the thermoplastic composition. In one embodiment, the metal coated fillers may be used in amounts of about 0.25 wt % to about 30 wt %, based on the total weight of the thermoplastic composition. In another embodiment, the metal coated fillers may be used in amounts of about 0.5 wt % to about 20 wt %, based on the total weight of the thermoplastic composition. In yet another embodiment, the metal coated fillers may be used in amounts of about 1 wt % to about 10 wt %, based on the total weight of the thermoplastic composition.

In one embodiment carbon fibers, VGCF, carbon nanotubes, carbon black, conductive metal fillers, conductive non-metal fillers, metal coated fillers as detailed above, or any combination of the foregoing may be used in the thermoplastic composition to render the thermoplastic composition electrostatically dissipative. An exemplary electrically conductive filler is carbon fiber. It is generally desirable to use the conductive fillers in amounts effective to produce surface resistivity less than or equal to about 10¹⁰ ohm/square as measured as per ASTM D 257. In another embodiment, it is desirable of have the surface resistivity of the thermoplastic composition be less than or equal to about 10⁷ ohm/square. In yet another embodiment, it is desirable of have the surface resistivity of the thermoplastic composition be less than or equal to about 10⁵ ohm/square.

It is also desirable to have the volume resistivity less than or equal to about 10¹² ohm-centimeter. In one embodiment, it is desirable to have the volume resistivity less than or equal to about 10⁶ ohm-centimeter. In another embodiment, it is desirable to have the volume resistivity less than or equal to about 10³ ohm-centimeter. In yet another embodiment, it is desirable to have the volume resistivity less than or equal to about 100 ohm-centimeter.

Other additives such as antioxidants, impact modifiers, flame retardants, anti-drip agents, antiozonants, stabilizers, anti-corrosion additives, mold release agents, fillers, anti-static agents, flow promoters, pigments, dyes, or the like, commonly used in thermoplastic compositions may also be added in the amounts desired.

The composition can be melt blended or solution blending. An exemplary process generally comprises melt blending. Melt blending of the composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations comprising at least one of the foregoing.

Melt blending involving the aforementioned forces may be conducted in machines such as, single or multiple screw extruders, Buss kneader, Eirich mixers, Henschel, helicones, Ross mixer, Banbury, roll mills, molding machines such as injection molding machines, vacuum forming machines, blow molding machines, or the like, or combinations comprising at least one of the foregoing machines. It is generally desirable during melt or solution blending of the composition to impart a specific energy of about 0.01 to about 10 kilowatt-hour/kilogram (kwhr/kg) of the composition.

The thermoplastic compositions can be manufactured by a number of methods. In one exemplary process, the thermoplastic polymers, the electrically conductive fillers, and additional optional ingredients are compounded in an extruder and extruded to produce pellets. In another exemplary process, the thermoplastic composition can also be mixed in a dry blending process (e.g., in a Henschel mixer) and directly molded, e.g., by injection molding or any other suitable transfer molding technique. It is desirable to have all of the components of the thermoplastic composition free from water prior to extrusion and/or molding.

In another exemplary method of manufacturing the thermoplastic composition, the electrically conductive fillers can be masterbatched into the blend of the thermoplastic polymers. The masterbatch may then be let down with additional thermoplastic polymer during the extrusion process or during a molding process to form the thermoplastic composition.

Exemplary extrusion temperatures are about 260 to about 400° C. The compounded thermoplastic composition can be extruded into granules or pellets, cut into sheets or shaped into briquettes for further downstream processing. The composition can then be molded in equipment generally employed for processing thermoplastic compositions, e.g., an injection molding machine with cylinder temperatures of about 250 to about 450° C., and mold temperatures of about 150 to about 300° C.

The thermoplastic compositions thus obtained display a number of advantageous properties over other available compositions. The thermoplastic compositions of the present disclosure display a useful combination of electrical conductivity and thermal and dimensional stability. In one embodiment, the thermoplastic composition undergoes a warpage of less than or equal to about 3 millimeter/100 square millimeters, expressed as a percentage, when annealed at a temperature of 275° C. for a period of 24 hours. In another embodiment, the thermoplastic composition undergoes a warpage of less than or equal to about 2 millimeter/10 square millimeters, expressed as a percentage, when annealed at a temperature of 275° C. for a period of 24 hours. In yet another embodiment, the thermoplastic composition undergoes a warpage of less than or equal to about 1 millimeter/10 square millimeters, expressed as a percentage, when annealed at a temperature of 275° C. for a period of 24 hours. In yet another embodiment, the article is an integrated circuit (IC) tray having dimensions meeting Joint Electron Device Engineering Council (JEDEC) specifications, i.e., having dimensions of 322.6 mm×135.9 mm×7.62 mm with warpage of less or equal to 0.76 mm, when annealed at a temperature of 275° C. for a period of 24 hours.

The thermoplastic composition can be molded to have a smooth surface finish. In one embodiment, the thermoplastic compositions or articles derived from the thermoplastic compositions can have a Class A surface finish. When the thermoplastic composition comprises electrically conductive fibrous fillers (e.g., carbon fibers, carbon nanotubes, carbon black, or combinations thereof) articles molded from the composition can have an electrical volume resistivity of less than of equal to about 10¹² ohm-cm. In one embodiment, the thermoplastic composition or articles molded from the thermoplastic composition can have an electrical volume resistivity of less than of equal to about 10⁸ ohm-cm. In another embodiment, the thermoplastic composition or articles molded from the thermoplastic composition can have an electrical volume resistivity of less than of equal to about 10⁵ ohm-cm. The thermoplastic composition or articles molded therefrom can also have a surface resistivity of less than or equal to about 10¹² ohm per square centimeter. In one embodiment, the thermoplastic composition or articles molded from the thermoplastic composition can also have a surface resistivity of less than or equal to about 10⁸ ohm per square centimeter. In another embodiment, the thermoplastic composition or articles molded from the thermoplastic composition can also have a surface resistivity of less than or equal to about 10⁴ ohm per square centimeter.

As noted above, the thermoplastic composition described herein can be advantageously used in the manufacture of a variety of commercial articles. An exemplary article is an integrated circuit chip tray. They can also be used in other applications where dimensional stability and/or electrical conductivity are desired such as automobiles interiors, aircraft, lamp shades, or the like.

The following examples, which are meant to be exemplary, not limiting, illustrate compositions and methods for manufacturing the thermoplastic compositions described herein.

### EXAMPLE

This example demonstrates the ability of the thermoplastic composition to withstand high temperatures. The compositions are shown in the Table 1. Sample #1 utilized polyetherketone ketone manufactured by Performance Polymers LLC. Sample #2 utilized a blend of Aurum PD 6200 and Ultem XH 6050. The Aurum PD 6200 is a blend of a polyimide and a crystalline resin and was obtained from Mitsui. The Ultem XH 6050 is a polyetherimide obtained from GE Plastics. Carbon fibers were used as the electrically conductive fillers. The carbon fibers used were Fortafil 203 supplied by Fortafil Fibers Inc. The compositions are shown in Table 1 below.

The formulations listed in Table 1 were extruded on a Werner-Pfleiderer 30 mm twin screw extruder. There were 10 barrels. The barrel temperatures were set at 300° C., 330° C., 350° C., 350° C., 350° C., 350° C., 350° C., 350° C., 350° C., and 350° C. from throat to die respectively, and the extruder was operated at 350 rpm. The die temperature was set at 350° C. The chip trays were molded on a Cincinnati 220 Ton injection molding machine. The barrel temperature in the injection molding machine was 400° C., while the mold temperature was 190° C. The melt temperatures and mold temperatures were a function of the resin being molded.

The trays were placed in a hot air oven preset at an evaluation temperature, for varying time periods as can be seen in Table 1. After the desired bake cycle, the oven temperature was lowered to 50° C. following which the trays were allowed to cool down for a minimum of 2 hours, prior to removing them from the oven. These trays were then allowed to equilibrate to ambient conditions for at least 30 minutes before dimensional measurements were taken. The dimensions of all trays were measured before and after exposure to elevated temperatures, as shown in Table 1. The length of the tray was re corded in millimeters and the warpage value recorded was a measure of the deviation of the tray from a flat surface along the length of the tray. The warp value provided in this disclosure is representative of either a center bow or a corner bow as shown in the FIG. 2.

TABLE 1

| | Sample #1 | Sample #2 |
|---|---|---|
| Material | | |
| PEKK C4000 (wt %) | 80 | |
| Aurum PD6200 | | 72 |
| (wt %) | | |
| Ultem XH6050 | | 18 |
| (wt %) | | |
| Aurum 450PD (wt %) | | |
| Radel A701 (wt %) | | |
| Fortafil 203 (wt %) | 20 | 10 |
| Properties | | |
| Tray Length (mm) | 315.03 | 314.66 |
| Tray Warp (mm) | 0.000 | 0.25 |
| 245° C./24 hrs Bake | | |
| Tray Length (mm) | 313.59 | 313.29 |
| Tray Warp (mm) | 0.000 | 0.63 |
| 255° C./24 hrs Bake | | |
| Tray Length (mm) | 313.58 | 313.53 |
| Tray Warp (mm) | 0.25 | 0.25 |
| 275° C./24 hrs Bake | | |
| Tray Length (mm) | 313.55 | |
| Tray Warp (mm) | 0.33 | |

From the Table 1, it may be seen that the warpage is generally less than about 1 millimeter/300 millimeters length when annealed at temperatures of about 245 to about 275° C. for periods of 24 hours. Thus the samples can be advantageously used in chip trays.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A thermoplastic article comprising:
a thermoplastic polymer having a glass transition temperature of greater than or equal to about 150° C.; and
an electrically conductive filler; wherein the thermoplastic article when annealed to a temperature of greater than or equal to about 245° C. for a period of greater than or equal to about 24 hours produces a warpage of less than or equal to about 3 millimeters/100 square millimeters, expressed as a percentage, and wherein the article has a volume resistivity of less than or equal to about 10¹² ohm-cm and a surface resistivity of less than or equal to about 10¹⁰ ohm per square.

2. The thermoplastic article of claim 1, wherein the article when annealed to a temperature of greater than or equal to about 245° C. for a period of greater than or equal to about 24 hours produces a warpage of less than or equal to about 1 millimeter/100 square millimeters, expressed as a percentage.

3. The thermoplastic article of claim 1, wherein the article having dimensions of 322.6 millimeters×135.9 millimeters×7.62 millimeters produces a warpage of less than or equal to about 0.76 millimeters, when annealed to a temperature of greater than or equal to about 245° C. for a period of greater than or equal to about 24 hours.

4. The thermoplastic article of claim 1, further having a Class A surface finish.

5. The thermoplastic article of claim 1, wherein the thermoplastic polymer can be an oligomer, a polymer, a copolymer, a random copolymer, a block copolymer, an alternating copolymer, an alternating block copolymer, a star block copolymer, a dendrimer, an ionomer, or a combination comprising at least one of the foregoing polymers.

6. The thermoplastic article of claim 1, wherein the thermoplastic polymer is a polyarylene sulfide, a polyalkyd, a polystyrene, a polyester, a polyamide, polyaramides, a polyamideimide, a polyarylate, a polyarylsulfone, a polyethersulfone, a polyimide, a polyetherimide, a polytetrafluoroethylene, a polyetherketone, a polyether etherketone, a polyether ketone ketone, a polybenzoxazole, a polyoxadiazole, a polybenzothiazinophenothiazine, a polybenzothiazole, a polypyrazinoquinoxaline, a polypyromellitimide, a polyquinoxaline, a polybenzimidazole, a polyoxindole, a polyoxoisoindoline, a polydioxoisoindoline, a polytriazine, a polypyridazine, a polypiperazine, a polypyridine, a polypiperidine, a polytriazole, a polypyrazole, a polycarborane, a polyoxabicyclononane, a polydibenzofuran, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polysulfonamide, a polyurea, a polyphosphazene, a polysilazane, or a combination comprising at least one of the foregoing thermoplastic polymers.

7. The thermoplastic article of claim 1, wherein the electrically conductive fillers are carbon nanotubes, carbon fibers, carbon black, metallic fillers, non-conductive fillers coated with metallic coatings, non-metallic fillers, or a combination comprising at least one of the foregoing electrically conductive fillers.

8. The thermoplastic article of claim 7, wherein the carbon nanotubes are single wall carbon nanotubes, multiwall carbon nanotubes or vapor grown carbon fibers.

9. The thermoplastic article of claim 7, wherein the carbon fibers are derived from pitch or polyacrylonitrile and have diameters of about 1 to about 30 micrometers.

10. The thermoplastic article of claim 7, wherein the metallic fillers are aluminum, copper, magnesium, chromium, tin, nickel, silver, iron, titanium or a combination comprising at least one of the foregoing metallic fillers.

11. The thermoplastic article of claim 7, wherein the non-metallic fillers are indium tin oxide, antimony oxide, tin oxide, or a combination comprising at least one of the foregoing non-metallic fillers.

12. The thermoplastic article of claim 1, comprising about 0.1 to about 80 weight percent of the electrically conductive filler, based on the total weight of the thermoplastic article.

13. The thermoplastic article of claim 1, comprising about 50 to about 99 weight percent of the thermoplastic polymer, based on the total weight of the thermoplastic article.

14. A thermoplastic article comprising:
a thermoplastic polymer; wherein the thermoplastic polymer is a polyimide, a polyetherimide, a polyether ketone, a polyether ketone ketone, a polyether ether ketone, a polysulfone, a polyether sulfone, a polyarylene sulfide, or a combination comprising at least one of the foregoing thermoplastic polymers; and
carbon fibers; wherein the thermoplastic article when annealed to a temperature of greater than or equal to about 245° C. for a period of greater than or equal to about 24 hours displays a warpage of less than or equal to about 3 millimeters/100 square millimeters, expressed as a percentage, and wherein the article has a volume resistivity of less than or equal to about 10¹² ohm-cm and a surface resistivity of less than or equal to about 10¹⁰ ohm per square.

15. The thermoplastic article of claim 14, comprising about 0.001 to about 80 weight percent of the carbon fibers, based on the total weight of the thermoplastic article.

16. The thermoplastic article of claim 14, comprising about 50 to about 99 weight percent of the thermoplastic polymer, based on the total weight of the thermoplastic article.

17. A method of manufacturing a thermoplastic article comprising:
blending a thermoplastic polymer with an electrically conductive filler in a manner effective to produce a thermoplastic article, which displays a warpage of less than or equal to about 3 millimeters/100 square millimeters, expressed as a percentage, when annealed to a temperature of greater than or equal to about 245° C. for a period of greater than or equal to about 24 hours and wherein the article has a volume resistivity of less than or equal to about 10¹² ohm-cm and a surface resistivity of less than or equal to about 10¹⁰ ohm per square.

18. The method of claim 17, wherein the blending comprises melt blending and/or solution blending.

19. The method of claim 17, wherein the blending is conducted in an extruder.

20. The method of claim 17, further comprising molding the thermoplastic article.

21. The method of claim 20, wherein the molding comprises injection molding.

22. A thermoplastic composition comprising:
a thermoplastic polymer having a glass transition temperature of greater than or equal to about 150° C.; and
an electrically conductive filler; wherein the thermoplastic composition when manufactured into an article that is annealed to a temperature of greater than or equal to about 245° C. for a period of greater than or equal to about 24 hours displays a warpage of less than or equal to about 3 millimeters/100 square millimeters, expressed as a percentage, and wherein the article has a volume resistivity of less than or equal to about 10¹² ohm-cm and a surface resistivity of less than or equal to about 10¹⁰ ohm per square.

23. The thermoplastic composition of claim 22, wherein the article having dimensions of 322.6 millimeters×135.9 millimeters×7.62 millimeters produces a warpage of less than or equal to about 0.76 millimeters, when annealed to a temperature of greater than or equal to about 245° C. for a period of greater than or equal to about 24 hours.

24. The thermoplastic composition of claim 22, wherein the article has a Class A surface finish.

25. The thermoplastic composition of claim 22, wherein the thermoplastic polymer can be an oligomer, a polymer, a copolymer, a random copolymer, a block copolymer, an alternating copolymer, an alternating block copolymer, a star block copolymer, a dendrimer, an ionomer, or a combination comprising at least one of the foregoing polymers.

26. The thermoplastic composition of claim 22, wherein the electrically conductive fillers are carbon nanotubes, carbon fibers, carbon black, metallic fillers, non-conductive fillers coated with metallic coatings, non-metallic fillers, or a combination comprising at least one of the foregoing electrically conductive fillers.

27. The thermoplastic composition of claim 26, wherein the carbon nanotubes are single wall carbon nanotubes, multiwall carbon nanotubes or vapor grown carbon fibers.

28. The thermoplastic composition of claim 26, wherein the carbon fibers are derived from pitch or polyacrylonitrile and have diameters of about 1 to about 30 micrometers.

29. The thermoplastic composition of claim 22, comprising about 0.1 to about 80 weight percent of the electrically conductive filler, based on the total weight of the thermoplastic composition.

30. The thermoplastic composition of claim 1, comprising about 50 to about 99 weight percent of the thermoplastic polymer, based on the total weight of the thermoplastic composition.

31. The thermoplastic article of claim 1, wherein the article is an integrated circuit tray.

32. The thermoplastic article of claim 14, wherein the article is an integrated circuit tray.
